(19) United States
(12) Patent Application Publication
(10) Pub. No.: US 2026/0146907 A1
(43) Pub. Date: May 28, 2026

(54) WHOLE-PLANE SIX-DIMENSIONAL FORCE SENSOR ELASTOMER

(71) Applicant: Harbin Institute of Technology, Harbin (CN)

(72) Inventors: Shicai Shi, Harbin (CN); Haibo Yu, Harbin (CN); Yuanfei Zhang, Harbin (CN); Yongjun Sun, Harbin (CN); Guocai Yang, Harbin (CN); Shaowei Fan, Harbin (CN); Le Qi, Harbin (CN); Hong Liu, Harbin (CN)

(21) Appl. No.: 19/393,971

(22) Filed: Nov. 19, 2025

(30) Foreign Application Priority Data
Nov. 26, 2024 (CN) 202411703309.7

(51) Int. Cl. G01L 5/1627

(52) U.S. Cl. CPC G01L 5/1627

(57) ABSTRACT

There is provided a whole-plane six-dimensional force sensor elastomer, which relates to the field of six-dimensional force sensor elastomers. The present disclosure aims to solve the problem of inability of the existing six-dimensional force sensor elastomers to maintain large bearing capacity while having small size and light weight. The elastomer of the present disclosure includes an outer ring and an inner ring. The outer ring is sleeved on an outer side of the inner ring, and four beam assemblies are disposed and connected between the outer ring and the inner ring. The four beam assemblies are equidistantly disposed circumferentially between the outer ring and the inner ring. An end of each beam assembly is disposed integrally with the outer ring and the other end of each beam assembly is disposed integrally with the inner ring. One strain measurement unit assembly is mounted on each beam assembly.

### CROSS-REFERENCE TO RELATED APPLICATION

This application claims priority from the Chinese patent application 202411703309.7 filed Nov. 26, 2024, the content of which is incorporated herein in the entirety by reference.

### TECHNICAL FIELD

The present disclosure relates to the field of six-dimensional force sensor elastomers and in particular to a whole-plane six-dimensional force sensor elastomer.

### BACKGROUND

The need of robots in new scene development process is now speeding up the requirements for the comprehensive performance of the six-dimensional force sensors. Nowadays, people expect not only the motion stability and accuracy of the robots but also the normal operation of the robots in large-load scenes. The six-dimensional force sensors have become one of key components of the robots due to its ability to sense full-force information of three-dimensional space, which naturally leads to sharply-increased demand for the six-dimensional force sensors with large bearing capacity.

The existing six-dimensional force sensors generally increase its bearing capacity by its larger thickness, which will increases unnecessary size and weight. If the thickness increase is not desired, the bearing capacity can be increased by using additional several bearing beams, which leads to larger increase of the transverse stiffness which does not need any increase and further to significant decrease of its transverse sensitivity. Furthermore, the strain measurement units of the existing six-dimensional force sensors are mostly arranged on different surfaces of the strain beams, resulting in tedious arrangement process and low efficiency.

Chinese patent CN1220037C discloses a miniature whole-plane six-dimensional force and moment sensor, which is shaped like flat disk structure and consists of a central body, three outer ring beams forming an angle of 60 degrees mutually around the central body, three inner ring beams forming an angle of 120 degrees mutually and disposed radially within the outer ring beams, and strain gauges. Each of the three outer ring beams is formed by a strain beam composed of two thin sheets. The inner ends of the three inner ring beams are connected with the central body, and the outer ends of the three inner ring beams are respectively connected to a connection position between two outer ring beams. The central body, the outer ring beams and the inner ring beams are connected to form an integral structure. A strain gauge is disposed on each outer ring beam and inner ring beam respectively. This sensor is a whole-plane structure which facilitates the disposal of the strain measurement units and is applicable to micro-machining. Also, the sensor features small volume and high accuracy and can be used for the finger tips of the dexterous hands of the second-generation humanoid robots to improve the intelligence degree of the whole robot system. But it is difficult for this sensor to maintain large bearing capacity while having small size and light weight.

Chinese patent CN115683434B discloses a six-axis force/moment measurement device adaptable to an inchworm-crawling spatial mechanical arm. This device uses a flexible load distribution beam to bear most force/moment load and can achieve overload protection while improving the stiffness of the measurement device; it also uses a T-type sensitivity beam of special structure to bear a small amount of force/moment load and can perform the function of detection and measurement. Based on actual working situations, the stiffness ratio of the load distribution beam and the sensitivity beam is properly determined to solve the contradiction between high stiffness and large overload and sensitivity, helping the device to be more adaptable to the inchworm-crawling spatial mechanical arm. This structure improves the measurement stiffness of the sensor, but this improvement is all-around, which can lead to overlarge improvement of the radial stiffness which does not need any improvement and further to significant decrease of the transverse sensitivity. Further, its strain measurement units are arranged within different planes and thus the strain measurement units cannot be arranged by sputtering process, leading to poor arrangement consistency and efficiency of the strain measurement units.

### SUMMARY

Aiming to solve the problem of inability of the existing six-dimensional force sensor elastomers to maintain large bearing capacity while having small size and light weight, the present disclosure provides a whole-plane six-dimensional force sensor elastomer.

There is provided a whole-plane six-dimensional force sensor elastomer, including an outer ring and an inner ring. The outer ring is sleeved on an outer side of the inner ring, and four beam assemblies are disposed and connected between the outer ring and the inner ring. The four beam assemblies are equidistantly disposed circumferentially between the outer ring and the inner ring. An end of each beam assembly is disposed integrally with the outer ring and the other end of each beam assembly is disposed integrally with the inner ring. One strain measurement unit assembly is mounted on each beam assembly.

Furthermore, the elastomer further includes four double-stiffness stiffening beams and each double-stiffness stiffening beam is located in the exact middle of two neighboring beam assemblies. Also, one end of each double-stiffness stiffening beam is disposed integrally with the outer ring, and the other end of each double-stiffness stiffening beam is disposed integrally with the inner ring.

Furthermore, each of the double-stiffness stiffening beams includes four stiffening beam bodies which are sequentially connected head to tail to form a rhombus. Two opposite tips of the double-stiffness stiffening beams are connection portions connecting with the outer ring and the inner ring respectively. One tip is disposed integrally with the outer ring and the other tip is disposed integrally with the inner ring.

Furthermore, each of the beam assemblies includes one inner beam and two parallel beams, and one end of the inner beam is disposed integrally with the inner ring, and the two parallel beams are disposed oppositely at both sides of the other end of the inner beam. One end of each parallel beam is disposed integrally with the inner beam by one flexible beam, and the other end of each parallel beam is disposed integrally with the outer ring. Each flexible beam and its corresponding parallel beam are located on a same centerline, and each flexible beam is disposed perpendicular to its corresponding inner beam.

Furthermore, each of the strain measurement unit assemblies includes a tensile strain measurement unit and two shear/compressive strain measurement unit groups. The tensile strain measurement unit is mounted on the top of the inner beam, and each shear/compressive strain measurement unit group is mounted correspondingly on the top of one parallel beam.

Furthermore, each shear/compressive strain measurement unit group includes two shear/compressive strain measurement units, and the two shear/compressive strain measurement units are symmetrically mounted on both ends of the top of the parallel beam where the two shear/compressive strain measurement units are located, along a lengthwise centerline of the parallel beam.

Furthermore, the tensile strain measurement unit on the inner beam and the shear/compressive strain measurement units on the parallel beam are all located within a same plane.

Furthermore, six inner ring through holes are opened equidistantly and circumferentially on the top of the inner ring, and two of the six inner ring through holes respectively correspond to two opposite inner beams.

Furthermore, eight outer ring through holes are circumferentially opened on the top of the outer ring, and four of the eight outer ring through holes are respectively disposed corresponding to one double-stiffness stiffening beam, and the other four of the eight outer ring through holes are respectively disposed corresponding to one inner beam.

Furthermore, the outer ring, the inner ring, the inner beams, the double-stiffness stiffening beams, the flexible beams, and the parallel beams are all made of aluminum alloy or stainless steel or alloy steel.

The present disclosure has the following beneficial effects, compared with the prior arts.
1. In the whole-plane six-dimensional force sensor elastomer provided by the present disclosure, the parallel beams are connected to the inner beams by the flexible beams. When a tangential force Fx or Fy acts in a direction perpendicular to a thickness direction of the flexible beams, the stiffness in a length and height direction of the flexible beams is far greater than the stiffness in the thickness direction, leading to smaller coupling effect in My or Mx direction and thus lowering the inter-dimensional coupling. Because the actions of the Mz and Fz are relatively independent, their coupling effect is smaller. The parallel beams are disposed between the flexible beams and the outer ring and the flexible beams are disposed on the centerline of the parallel beams, such that the size of the sensor is less affected by the size of the parallel beams, making the elastomer structure more compact. Furthermore, this arrangement solution also reduces the distance from the flexible beams to the center of the sensor, and hence reduces the torsional deformation of the flexible beams under force, improving the elastomer stiffness and sensitivity.
2. In the whole-plane six-dimensional force sensor elastomer provided by the present disclosure, with the double-stiffness stiffening beams, the axial stiffness can be improved and the elastomer thickness can be reduced, without changing the transverse sensitivity of the elastomer. Furthermore, the problem of excessively increasing the thickness of the parallel beams when increasing the axial stiffness can be avoided and the excessive strain difference of the strain measurement area of the same parallel beam can also be avoided, thereby improving the measurement sensitivity of the elastomer in Fz, Mx and My directions.
3. In the whole-plane six-dimensional force sensor elastomer provided by the present disclosure, the elastomer is designed as whole-plane structure so that the strain measurement units are all located within a same plane of the elastomer and the strain measurement units can be arranged on the elastomer by sputtering process, thereby improving the arrangement accuracy and efficiency of the strain measurement units.

### BRIEF DESCRIPTIONS OF THE DRAWINGS

FIG. 1 is a schematic diagram illustrating an entire structure of a whole-plane six-dimensional force sensor elastomer according to the present disclosure.

Numerals of the drawings are described below: 1. outer ring, 2. outer ring through hole, 3. flexible beam, 4. parallel beam, 5. double-stiffness stiffening beam, 6. inner beam, 7. inner ring, 8. inner ring through hole, 9. pin hole, 10. tensile strain measurement unit, and 11. shear/compressive strain measurement unit.

### DETAILED DESCRIPTIONS OF EMBODIMENTS

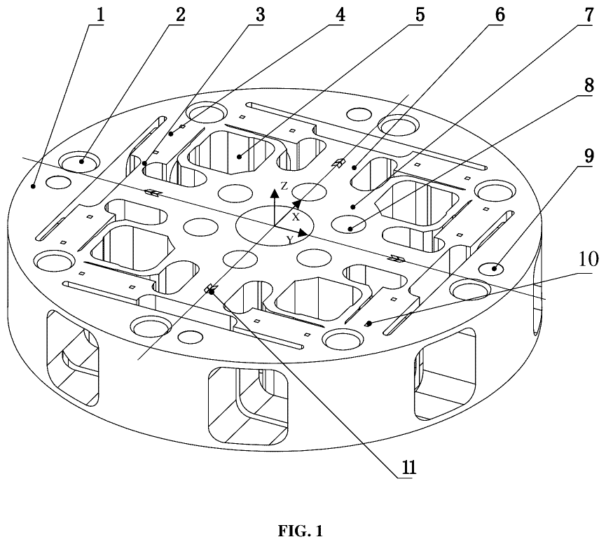

Specific embodiment 1: this embodiment is described in combination with FIG. 1. In this embodiment, there is provided a whole-plane six-dimensional force sensor elastomer, which includes an outer ring 1 and an inner ring 7. The outer ring 1 is sleeved on an outer side of the inner ring 7, and four beam assemblies are disposed and connected between the outer ring 1 and the inner ring 7. The four beam assemblies are equidistantly disposed circumferentially between the outer ring 1 and the inner ring 7. An end of each beam assembly is disposed integrally with the outer ring 1 and the other end of each beam assembly is disposed integrally with the inner ring 7. One strain measurement unit assembly is mounted on each beam assembly.

Specific embodiment 2: this embodiment is described in combination with FIG. 1. This embodiment differs from the specific embodiment 1 in that the elastomer further includes four double-stiffness stiffening beams 5; each double-stiffness stiffening beam 5 is located in the exact middle of two neighboring beam assemblies; also, one end of each double-stiffness stiffening beam 5 is disposed integrally with the outer ring 1, and the other end of each double-stiffness stiffening beam 5 is disposed integrally with the inner ring 7. Other composition and connection manners are the same as in the specific embodiment 1.

Specific embodiment 3: this embodiment is described in combination with FIG. 1. This embodiment differs from the specific embodiment 2 in that each of the double-stiffness stiffening beams 5 includes four stiffening beam bodies which are sequentially connected head to tail to form a rhombus; two opposite tips of the double-stiffness stiffening beams 5 are connection portions connecting with the outer ring 1 and the inner ring 7 respectively; one tip is disposed integrally with the outer ring 1 and the other tip is disposed integrally with the inner ring 7. Other composition and connection manners are the same as in the specific embodiment 2.

In combination with the specific embodiment 2 and the specific embodiment 3, the following descriptions are made: with the double-stiffness stiffening beams 5, the axial stiffness can be improved and the elastomer thickness can be reduced, without changing the transverse sensitivity of the elastomer. Furthermore, the problem of excessively increasing the thickness of the parallel beams when increasing the axial stiffness can be avoided and the excessive strain difference of the strain measurement area of the same parallel beam 4 can be avoided, thereby improving the measurement sensitivity of the elastomer in Fz, Mx and My directions.

Specific embodiment 4: this embodiment is described in combination with FIG. 1. This embodiment differs from the specific embodiment 3 in that each of the beam assemblies includes one inner beam 6 and two parallel beams 4, and one end of the inner beam 6 is disposed integrally with the inner ring 7, and the two parallel beams 4 are disposed oppositely at both sides of the other end of the inner beam 6. One end of each parallel beam 4 is disposed integrally with the inner beam 6 by one flexible beam 3, and the other end of each parallel beam 4 is disposed integrally with the outer ring 1. Each flexible beam 3 and its corresponding parallel beam 4 are located on a same centerline, and each flexible beam 3 is disposed perpendicular to its corresponding inner beam 6. Other composition and connection manners are the same as in the specific embodiment 3.

In this embodiment, the parallel beams are disposed between the flexible beams and the outer ring and the flexible beams are disposed on the centerline of the parallel beams, such that the size of the sensor is less affected by the size of the parallel beams, making the elastomer structure more compact. Furthermore, this arrangement solution also reduces the distance from the flexible beams to the center of the sensor, and hence reduces the torsional deformation of the flexible beams under force, improving the elastomer stiffness and sensitivity.

In this embodiment, a T-shaped groove structure is formed between the beam assembly formed by both the inner beam 6 and the two parallel beams 4 and the outer ring 1, and this T-shaped groove structure helps heat dissipation for the sensor elastomer.

Specific embodiment 5: this embodiment is described in combination with FIG. 1. This embodiment differs from the specific embodiment 4 in that each of the strain measurement unit assemblies includes a tensile strain measurement unit 10 and two shear/compressive strain measurement unit groups. The tensile strain measurement unit 10 is mounted on the top of the inner beam 6, and each shear/compressive strain measurement unit group is mounted correspondingly on the top of one parallel beam 4. Other composition and connection manners are the same as in the specific embodiment 4.

Specific embodiment 6: this embodiment is described in combination with FIG. 1. This embodiment differs from the specific embodiment 5 in that each shear/compressive strain measurement unit group includes two shear/compressive strain measurement units 11, and the two shear/compressive strain measurement units 11 are symmetrically mounted on both ends of the top of the parallel beam 4 where the two shear/compressive strain measurement units 11 are located, along a lengthwise centerline of the parallel beam 4. Other composition and connection manners are the same as in the specific embodiment 5.

Specific embodiment 7: this embodiment is described in combination with FIG. 1. This embodiment differs from the specific embodiment 6 in that the tensile strain measurement unit 10 on the inner beam 6 and the shear/compressive strain measurement units 11 on the parallel beam 4 are all located within a same plane. Other composition and connection manners are the same as in the specific embodiment 6.

In combination with the specific embodiments 5 to 7, the following descriptions are made: the tensile strain measurement unit 10 and the shear/compressive strain measurement units 11 are all arranged on the elastomer by sputtering process, helping improve the arrangement accuracy and efficiency of the strain measurement units.

Specific embodiment 8: this embodiment is described in combination with FIG. 1. This embodiment differs from the specific embodiment 7 in that six inner ring through holes 8 are opened equidistantly and circumferentially on the top of the inner ring 7, and two of the six inner ring through holes 8 respectively correspond to two opposite inner beams 6. Other composition and connection manners are the same as in the specific embodiment 7.

Specific embodiment 9: this embodiment is described in combination with FIG. 1. This embodiment differs from the specific embodiment 8 in that eight outer ring through holes 2 are circumferentially opened on the top of the outer ring 1, and four of the eight outer ring through holes 2 are respectively disposed corresponding to one double-stiffness stiffening beam 5, and the other four of the eight outer ring through holes 2 are respectively disposed corresponding to one inner beam 6. Other composition and connection manners are the same as in the specific embodiment 8.

In combination with the specific embodiments 8 and 9, the following descriptions are made: for each outer ring through hole 2 disposed corresponding to the double-stiffness stiffening beam 5 on the top of the outer ring 1, the central point of the outer ring through hole 2 is located on a line connecting the central point of the inner ring 7 and the central point of the double-stiffness stiffening beam 5 corresponding to the outer ring through hole 2; for each outer ring through hole 2 disposed corresponding to the inner beam 6 on the top of the outer ring 1, the central point of the outer ring through hole 2 is located at a side of a line connecting the central point of the inner ring 7 and the central point of the inner beam 6 corresponding to the outer ring through hole 2; four pint holes 9 are also processed on the top of the outer ring 1, and each point hole 9 is located at the other side of the line connecting the central point of the inner ring 7 and the central point of one inner beam 6.

Specific embodiment 10: this embodiment is described in combination with FIG. 1. This embodiment differs from the specific embodiment 9 in that the outer ring 1, the inner ring 7, the inner beams 6, the double-stiffness stiffening beams 5, the flexible beams 3, and the parallel beams 4 are all made of aluminum alloy or stainless steel or alloy steel. Other composition and connection manners are the same as in the specific embodiment 9.

The present disclosure has been disclosed as above with preferred embodiments but is not limited by these embodiments. Those skilled in the arts can, within the scope of the technical solutions of the present disclosure, make equivalent implementations with some changes or modifications as equivalent changes by using the above-disclosed structures and technical contents. Any simple changes, equivalent changes and modifications made to the above embodiments based on the technical essence of the present disclosure without departing from the contents of the technical solutions of the present disclosure shall all fall within the scope of technical solutions of the present disclosure.

### Working principle

Taking the measurement of the tangential force Fx as example: the tangential force Fx is applied to the lower end surface of the inner ring 7, and the upper end surface of the outer ring 1 is a fixed surface, and the stiffness of the flexible beams 3 in the length direction (in the X axis direction) is greater than the stiffness in the thickness direction (in the Y axis direction). Therefore, the inner beams 6, the parallel beams 4, the double-stiffness stiffening beams 5 and the flexible beams 3 in parallel to the Fx direction are all regarded as stiff, and the inner beams 6, the parallel beams 4, the double-stiffness stiffening beams 5 and the flexible beams 3 perpendicular to the Fx direction are all regarded as flexible, and the inner beams 6 perpendicular to the Fx direction are regarded as cantilever beams. A strain sensitivity area is formed on the inner beams 6. In this way, a strain bridge is formed to measure Fx. Similarly, the tangential force Fy can be measured.

Taking the measurement of the axial force Fz as example: the axial force Fz is applied to the lower end surface of the inner ring 7, the upper end surface of the outer ring 1 is a fixed surface, and the force is transmitted to the parallel beams 4 by the inner beams 6. The stiffness of the flexible beams 3 and the double-stiffness stiffening beams 5 in the Z axis direction is greater than the stiffness in the X axis and Y axis directions, and the stiffness of the parallel beams 4 in the X axis and Y axis directions is greater than the stiffness in the Z axis direction. Therefore, the inner beams 6, the double-stiffness stiffening beams 5 and the flexible beams 3 are regarded as stiff, and the parallel beams 4 are regarded as flexible. The axial force Fz is transmitted to the parallel beams 4 by the four uniformly-distributed inner beams 6 and the flexible beams 3. A strain sensitivity area is formed on the parallel beams 4 and thus a strain bridge is formed to measure the Fz.

Taking the measurement of the bending moment Mx as example: the bending moment Mx is applied to the lower end surface of the inner ring 7, the upper end surface of the outer ring 1 is a fixed surface, and the bending moment is transmitted to the parallel beams 4 by the inner beams 6. The stiffness of the flexible beams 3 and the double-stiffness stiffening beams 5 in the Z axis direction is greater than the stiffness in the X axis and Y axis directions, and the stiffness of the parallel beams 4 in the X axis and Y axis directions is greater than the stiffness in the Z axis direction. Therefore, the inner beams 6, the double-stiffness stiffening beams 5 and the flexible beams 3 are regarded as stiff, and the parallel beams 4 are regarded as flexible. The bending moment Mx is transmitted to the parallel beams 4 by the four uniformly-distributed inner beams 6 and the flexible beams 3. A strain sensitivity area is formed on the parallel beams 4 and thus a strain bridge is formed to measure the Mx. Similarly, the tangential force My can be measured.

Taking the measurement of the torque Mz as example: the torque Mz is applied to the lower end surface of the inner ring 7, the upper end surface of the outer ring 1 is a fixed surface, and the stiffness of the flexible beams 3 in the length and Z axis directions is greater than the stiffness in the thickness direction. The actual action of the torque Mz is equivalent to a pile of couples of same size. Assuming the directions of the two acting forces of the couples are parallel to the X axis, the inner beams 6, the parallel beams 4 and the flexible beams 3 with the length direction parallel to the X axis direction are all regarded as stiff, and the flexible beams 3 with the length direction parallel to the Y axis direction are regarded as flexible. At this point, the inner beams 6 in parallel to the Y axis direction are regarded as cantilever beams. A strain sensitivity area is formed on the inner beams 6 and thus a strain bridge is formed to measure the Mz.

1. A whole-plane six-dimensional force sensor elastomer, wherein the elastomer comprises an outer ring (1) and an inner ring (7), the outer ring (1) is sleeved on an outer side of the inner ring (7), four beam assemblies are disposed and connected between the outer ring (1) and the inner ring (7), the four beam assemblies are equidistantly disposed circumferentially between the outer ring (1) and the inner ring (7), an end of each beam assembly is disposed integrally with the outer ring (1) and the other end of each beam assembly is disposed integrally with the inner ring (7), and one strain measurement unit assembly is mounted on each beam assembly;
the elastomer further comprises four double-stiffness stiffening beams (5) and each double-stiffness stiffening beam (5) is located in the exact middle of two neighboring beam assemblies, one end of each double-stiffness stiffening beam (5) is disposed integrally with the outer ring (1), and the other end of each double-stiffness stiffening beam (5) is disposed integrally with the inner ring (7);
each of the double-stiffness stiffening beams (5) comprises four stiffening beam bodies which are sequentially connected head to tail to form a rhombus, two opposite tips of the double-stiffness stiffening beams (5) are connection portions connecting with the outer ring (1) and the inner ring (7) respectively, one tip is disposed integrally with the outer ring (1) and the other tip is disposed integrally with the inner ring (7);
each of the beam assemblies comprises one inner beam (6) and two parallel beams (4), one end of the inner beam (6) is disposed integrally with the inner ring (7), the two parallel beams are disposed oppositely at both sides of the other end of the inner beam (6), one end of each parallel beam is disposed integrally with the inner beam (6) by one flexible beam (3), the other end of each parallel beam (4) is disposed integrally with the outer ring (1), each flexible beam (3) and its corresponding parallel beam (4) are located on a same centerline, and each flexible beam (3) is disposed perpendicular to its corresponding inner beam (6).

2-4. (canceled)

5. The whole-plane six-dimensional force sensor elastomer according to claim 1, wherein each of the strain measurement unit assemblies comprises a shear strain measurement unit (11) and two tensile/compressive strain measurement unit groups, the shear strain measurement unit (11) is mounted on the top of the inner beam (6), and each tensile/compressive strain measurement unit group is mounted correspondingly on the top of one parallel beam (4).

6. The whole-plane six-dimensional force sensor elastomer according to claim 5, wherein each tensile/compressive strain measurement unit group comprises two tensile/compressive strain measurement units (10), and the two tensile/compressive strain measurement units (10) are symmetrically mounted on both ends of the top of the parallel beam (4) where the two tensile/compressive strain measurement units (10) are located, along a lengthwise centerline of the parallel beam (4).

7. The whole-plane six-dimensional force sensor elastomer according to claim 6, wherein the shear strain measurement unit (11) on the inner beam (6) and the tensile/compressive strain measurement units (10) on the parallel beam (4) are all located within a same plane.

8. The whole-plane six-dimensional force sensor elastomer according to claim 7, wherein six inner ring through holes (8) are opened equidistantly and circumferentially on the top of the inner ring (7), and two of the six inner ring through holes (8) respectively correspond to two opposite inner beams (6).

9. The whole-plane six-dimensional force sensor elastomer according to claim 8, wherein eight outer ring through holes (2) are circumferentially opened on the top of the outer ring (1), and four of the eight outer ring through holes (2) are respectively disposed corresponding to one double-stiffness stiffening beam (5), and the other four of the eight outer ring through holes (2) are respectively disposed corresponding to one inner beam (6).

10. The whole-plane six-dimensional force sensor elastomer according to claim 9, wherein the outer ring (1), the inner ring (7), the inner beams (6), the double-stiffness stiffening beams (5), the flexible beams (3), and the parallel beams (4) are all made of aluminum alloy or stainless steel or alloy steel.
